(19) United States
(12) Patent Application Publication
(10) Pub. No.: US 2008/0288520 A1
(43) Pub. Date: Nov. 20, 2008

(54) Node Processing of Variable Information Print Jobs

(76) Inventor: Thomas Robson, Rochester, NY (US)

Correspondence Address: Gibb & Rahman, LLC, 2568-A Riva Road Suite 304, Annapolis, MD, 21401, US

(21) Appl. No.: 11/749,822

(22) Filed: May 17, 2007

(51) Int. Cl. G06F 17/00

(52) U.S. Cl. 707/101; 707/E17.008

(57) ABSTRACT

Embodiments herein begin by receiving user input. The embodiments herein create a fixed data file and a text string based on the user input using a process manager located within a system. The embodiments herein also supply the fixed data file and the text string from the process manager to at least one node within the system. The system comprises a plurality of such nodes. The node executes the text string to add variable data to the fixed data and create a variable information print file. More specifically, the node retrieves the variable data from a database within the system. Then, the method can print the variable information print file.

### BACKGROUND AND SUMMARY

Embodiments herein generally relate to the creation of variable information printing files and more particularly to a system, service, method, computer program, etc., that creates the variable information file at nodes of a system by sending the fixed data in a file and instructions to obtain the variable data in an inquiry.

Variable information print files contain “fixed” data that is unique to the specific document to be printed, and also contain “variable” information comprising other items that are to be included within the printed document. Such variable information can generally be drawn from some outside source. For example, U.S. Patent Publication 2005/0268217 (the complete disclosure of which is incorporated herein by reference) describes that a programmer typically uses an electronic representation of the paper form image in, for example, portable document format (“PDF”) to create a paper form from electronic data. Electronic forms can be written in extensible mark-up language (“XML”). The programmer creates data fields on the PDF image for inserting variables. These data fields serve as a template, describing a region on the PDF image and an associated variable. A program then applies the template to instances of the electronic XML form to put the data into the data fields on the PDF file.

U.S. Patent Publication 2006/0138227 (the complete disclosure of which is incorporated herein by reference) provides a brief overview of the operation of various software components involved with variable information documents. In this example, the XML input data stream includes a text string that identifies the name and location of other required documents or files. One such document is referred to as “XML schema” or “schema.” The schema is used to validate the XML input data stream, including the underlying value data. If validation is successful, a stylesheet is applied. The name and location of the stylesheet is also specified in the XML input data stream. Application of the stylesheet is handled by a processor, which under the direction of the stylesheet, may transform the underlying XML element names and/or underlying value data. The data is processed by the processor, which handles formatting and “layout” of the underlying value data, which may include, for example, formatting the underlying value data in accordance with, for example, font type, font size, color, and the like. The underlying value data is processed by a bitmap rendering engine, which creates a bitmap corresponding to the transformed and formatted data. A bitmap rendering engine may utilize an “instream foreign object” residing in the stylesheet to direct creation of the bitmap. The bitmap is then sent to a printer driver for subsequent printing.

Embodiments herein include a method that begins by receiving user input. The method creates a fixed data file and a text string based on the user input using a process manager located within a system. The method also supplies the fixed data file and the text string from the process manager to at least one node within the system. The system comprises a plurality of such nodes. The node executes the text string to add variable data to the fixed data and create a variable information print file. More specifically, the node retrieves the variable data from a database within the system. Thus, the method can print the variable information print file.

The user input comprises an inquiry to obtain the variable data from the database, such that when the method creates the text string, the text string includes the inquiry. The fixed data file can comprise a Postscript file, a portable document format (PDF) file, an open document format (ODF) file, etc. Similarly, the text string can comprise an extensible mark-up language (XML) file. One feature of embodiments herein is that the node is exclusively dedicated to only performing variable information processing.

Embodiments herein also comprise systems as well as methods. One such system includes a graphic user interface that is adapted to receive the user input. A processor (which is operatively connected to the graphic user interface) is adapted to create the fixed data file and the text string (that are based on the user input, as described above). The processor can comprise or include a process manager (which is operatively connected to, or is part of the processor).

The system further comprises a plurality of nodes (which are, in turn, operatively connected to the process manager). The process manager is adapted to pass the fixed data file and the text string from the processor to at least one of the nodes. Additionally, a database is operatively connected to the nodes. Consistent with the previously described method, the node is adapted to execute the text string by retrieving variable data from the database and adding the variable data to the fixed data so as to create the variable information print file. Finally, a printer is operatively connected to the node. Again, the node is adapted to print the variable information print file using the printer.

Consistent with the method embodiments, the processor is further adapted to create the text string to include the user's inquiry to obtain the variable data from the database and each node is exclusively dedicated to only performing variable information processing. These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating an embodiment herein;

FIG. 2 is a schematic representation of a system according to embodiment herein; and

FIG. 3 is a schematic representation of a system according to embodiment herein.

### DETAILED DESCRIPTION

Embodiments herein provide a process manager as a platform for integrating applications that produce variable information print files so that the applications can be run automatically with no user intervention (if desired). With embodiments herein, the applications are built as nodes which are run by a process manager. The process manager node provides a PDF document and an XML text string containing information as data to each of the individual nodes. Thus, with embodiments herein, the nodes build the variable data jobs. Each of the nodes conform to the process manager node interface specifications.

Document formats such as PDF and Postscript are not the most useful in variable data printing because much of the high level logical information about the document has been removed in such formats, and only positional information remains. However, with embodiments herein, an XML document format can be used as a processing format for a process manager in variable data configurations because the variable information file is built at each individual node. The process manager is responsible for creating the data required by the node. Thus, the user can select a PDF file (as the fixed data) and specify a database and a standard query language (SQL) inquiry to instruct the node to extract records from a given database to obtain the variable data.

With embodiments herein a suitable user interface is provided to allow the SQL to be constructed in a user friendly manner. Further, with embodiments herein, the user is provided the ability to specify the positions of the variable data on the page. Alternatively, the position information may also be in the database. This SQL data is wrapped in XML and passed to a process manager, which then forwards the XML file to the node that will build the variable information print job.

Some embodiments herein are useful with extensible mark-up language open document format (XML-ODF) files. XML-ODF files can be edited in process nodes. With embodiments herein the nodes can perform such actions as text insertion and reflow, which are useful when working with advanced variable data applications. Thus, with these embodiments, the fixed information in the XML-ODF format and a reference to the variable data (in XML format) contained in the process manager's database are passed to the node.

For example, the text string that references the variable information can take the form of a path to a data file or an SQL inquiry into a database. By either reading the data file or the database records, the variable data is obtained and merged with the fixed data in the way specified in the XML data. When this information gets to the variable data node (PDF and XML) the variable data is extracted from the database, the PDL is converted to Postscript (if necessary) and a variable data package (e.g. VIPP) is constructed. Then, when the job is eventually sent to the printer the VIPP is converted to PostScript, PDF, etc., by the printer node as with other jobs. By changing the XML record, the embodiments herein therefore automate the preparation and printing of variable data.

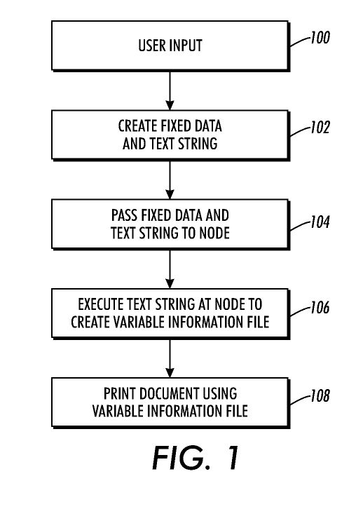

Referring now to the drawings, as shown in flowchart form in FIG. 1, embodiments herein include a method, service, computer program, etc., that begins in item 100 by receiving user input. In item 102, the process manager creates a fixed data file and a text string based on the user input. Then, in item 104, the system manager passes the fixed data file and the text string to at least one node within the system that will built the variable information print file.

With respect to the details of document assembly programs, reference is made to U.S. Patent Publication 2006/0036612, the complete disclosure of which is incorporated herein by reference. In 2006/0036612 a document assembly or document automation system includes an assembler for generating an instance document on the basis of a source document and one or more logic source documents referenced by the source document. The source document and logic source documents are XML documents and include at least one XML processing instruction. The source document and logic source documents are valid with respect to XML schema. The system generates an instance document in hypertext mark-up language (HTML), PDF or rich text format (RTF) format by resolving variables in the source document and/or logic sources using one or more data sources. This can involve performing one or more interview rounds with a user of the system, access to a database, and/or evaluation of a function defined in one of the documents. The system includes an editor for creating and maintaining source documents and logic source documents whilst maintaining their validity with respect to the appropriate XML schema.

The node executes the text string to add variable data to the fixed data and create a variable information print file in item 106. More specifically, the node retrieves the variable data from a database within the system. Thus, the method can print the document using the variable information print file in item 108.

The user input 100 comprises an inquiry to obtain the variable data from the database, such that when the method creates the text string in item 102, the text string includes the inquiry. The fixed data file created in item 102 can comprise a Postscript file, a portable document format (PDF) file, an open document format (ODF) file, etc. Similarly, the text string created in item 102 can comprise an extensible mark-up language (XML) file and other similar file formats.

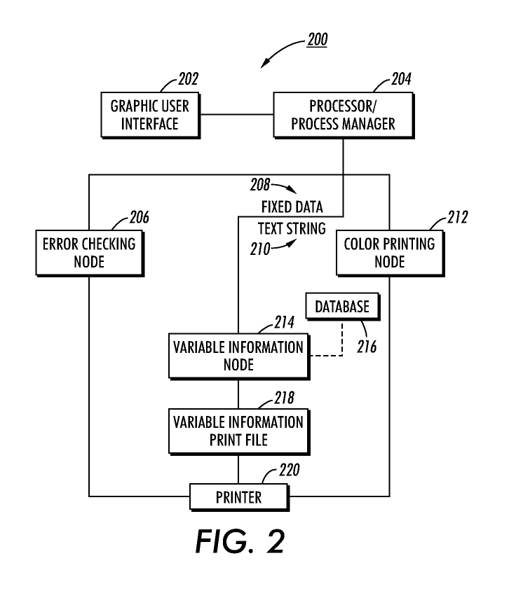

As shown in the system embodiment in FIG. 2, embodiments herein also comprise systems as well as the nodes themselves. With respect to the details of such systems, one exemplary system is disclosed in U.S. Patent Publication 2004/0196498 (the complete disclosure of which is incorporated herein by reference). More specifically, U.S. Patent Publication 2004/0196498 discloses a printing system that includes a printer and a plurality of processing nodes, where each processing node processes a portion of a print job into a printer dependent format. In U.S. Patent Publication 2004/0196498 a processing manager is used for spooling the print job into selectively sized chunks and assigning the chunks to selected ones of the nodes for parallel processing of the chunks by the processing nodes. The chunks are selectively sized from at least one page to an entire size of the print job in accordance with predetermined splitting factors for enhancing printing efficiency. Therefore, with respect to the details of such printing systems, reference is made to U.S. Patent Publication 2004/0196498 and the details of such printing systems are omitted herefrom to allow the reader to focus on the salient aspects of the embodiments described herein.

The exemplary system 200 shown in FIG. 2 includes a graphic user interface 202 that is adapted to receive the user input. A processor 204 (which is operatively connected to the graphic user interface) is adapted to create the fixed data file 206 and the text string 210 (that are based on the user input, as described above). The processor 204 can include or can run a process manager. Therefore, FIG. 2 illustrates the processor and process manager combined as item 204, although one ordinarily skilled in the art would understand that the two could be represented separately.

With respect to the processor and graphic user interface devices, computers are readily available devices produced by manufactures such as International Business Machines Corporation, Armonk N.Y., USA and Apple Computer Co., Cupertino Calif., USA. Such computers commonly include input/output devices, power supplies, processors, electronic storage memories, wiring, etc., the details of which are omitted herefrom to allow the reader to focus on the salient aspects of the embodiments described herein. The computer can include computer-usable data carriers storing instructions to perform the methods outlined herein.

The system includes and a plurality of nodes 206, 212, 214 (which are, in turn, operatively connected to the process manager 204). The different nodes are selectively enabled by the user through the graphic user interface 202, depending upon the printing functions that will be performed. For example, the user may enable the color printing node 212 for color printing, or enable the variable information node 214 to produce variable information print jobs.

While three nodes are illustrated in FIG. 2, one ordinarily skilled in the art would understand that there could be many more nodes (or potentially less nodes or different nodes) depending upon the features that are offered by the process manager 204. The more nodes that are included in the system, the more features the process manager 204 will offer to the user.

Thus, for example, the error checking node 206 can comprise a preflight print checking module that checks print jobs before they are sent to the printer. The preflight print checking tools can be included in the process manager discussed above, or stand alone preflight print checking tools are readily available from vendors, such as Markzware USA, Santa Ana, Calif., USA, for example. Similarly, the color printing node 212 can be adapted to process the various specialized printing functions associated with color printing. For example, color printing modules are available from manufactures such as Xerox Corporation, Stamford, Conn., USA.

Consistent with the method embodiments discussed previously, the processor 204 is further adapted to create the text string 210 to include the user's inquiry to obtain the variable data from the database 216. The processor 204 is adapted to pass the fixed data 208 and the text string 210 from the processor 204 to variable information node 214. Additionally, a database 216 is operatively connected to variable information node 214.

The variable information node 214 is a specialized node and is exclusively dedicated to only performing variable information processing so that the variable information print file 218 can be printed using the printer 220. Thus, the process of accessing the database 216 and combining the fixed data 208 with the variable data from the database 216 is performed at the variable information node 214 to produce the variable information print file 218 which is printed by the printer 220. By including the variable information processing actions within the variable information node 214, more sophistication and flexibility is added to the process manager system. This provides the user with more choices (to include or exclude a variable information printing action) when using the process manager.

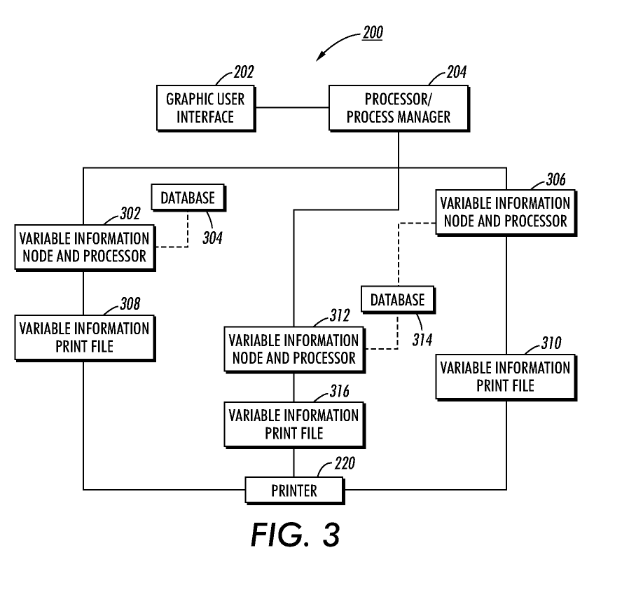

Further, as shown in FIG. 3, the embodiments herein can utilize a plurality of variable information nodes 302, 306, 312 to create multiple variable information print files 308, 310, 316 in parallel (e.g., simultaneously). The plurality of variable information nodes 302, 306, 312 helps speed processing because they can be simultaneously handled by separate processors (shown as being combined with the nodes in FIG. 3) or separate portions of a multi-function processor. Further, the plurality of variable information nodes can each execute a different text string and/or access different databases (304, 314). While FIG. 3 only illustrates variable information nodes, one ordinarily skilled in the art would understand that other nodes, such as those shown in FIG. 2 could be included also.

As shown above, the nodes can be connected (directly or indirectly) to a printer 220. With respect to the printer 220, the words printer, printing device, etc. as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art. Printers are readily available devices produced by manufactures such as Xerox Corporation, Stamford, Conn., USA. Such printers commonly include input/outputs, power supplies, processors, media movement devices, marking devices etc., the details of which are omitted herefrom to allow the reader to focus on the salient aspects of the embodiments described herein. All foregoing embodiments are specifically applicable to electrostatographic and/or xerographic machines and/or processes.

Thus, as shown above, embodiments herein provide a process manager as a platform for integrating applications that produce variable information print files so that the applications can be run automatically with no user intervention (if desired). With embodiments herein, the applications are built as nodes which are run by the process manager. The process manager node provides a PDF document and an XML text string containing information as data to each of the individual nodes. Thus, with embodiments herein, the nodes build the variable data jobs. Each of the nodes conform to the process manager node interface specifications.

With embodiments herein, an XML document format can be used as a processing format for a process manager in variable data configurations because the variable information file is built at each individual node. The process manager creates the data required by the node. Thus, with these embodiments the user can easily select a PDF file (as the fixed data) and specify a database and a standard query language (SQL) inquiry to instruct the node to extract records from a given database to obtain the variable data.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

What is claimed is:

1. A method comprising:
receiving user input;
creating a fixed data file and a text string based on said user input;
supplying said fixed data file and said text string to at least one node within a system comprising a plurality of nodes; and
executing said text string at said node to add variable data to said fixed data and create a variable information print file,
wherein said executing of said text string comprises retrieving said variable data from a database within said system.

2. The method according to claim 1, wherein said user input comprises an inquiry and said creating of said text string comprises including said inquiry within said text string.

3. The method according to claim 1, wherein said fixed data file comprises one of a portable document format (PDF) file and an open document format (ODF) file.

4. The method according to claim 1, wherein said text string comprise an extensible mark-up language (XML) file.

5. The method according to claim 1, wherein said node is exclusively dedicated to only performing variable information processing.

6. A method comprising:
receiving user input;
creating a fixed data file and a text string based on said user input using a process manager located within a system;
supplying said fixed data file and said text string from said process manager to at least one node within said system, wherein said system comprises a plurality of nodes; and
executing said text string at said node to add variable data to said fixed data and create a variable information print file,
wherein said executing of said text string comprises retrieving said variable data from a database within said system.

7. The method according to claim 6, wherein said user input comprises an inquiry and said creating of said text string comprises including said inquiry within said text string.

8. The method according to claim 6, wherein said fixed data file comprises one of a portable document format (PDF) file and an open document format (ODF) file.

9. The method according to claim 6, wherein said text string comprise an extensible mark-up language (XML) file.

10. The method according to claim 6, wherein said node is exclusively dedicated to only performing variable information processing.

11. A system comprising:
a graphic user interface adapted to receive user input;
a processor operatively connected to said graphic user interface, wherein said processor is adapted to create a fixed data file and a text string based on said user input;
a plurality of nodes operatively connected to said processor, wherein said processor is adapted to pass said fixed data file and said text string from said processor to at least one node; and
a database operatively connected to said node, wherein said node is adapted to execute said text string by retrieving variable data from said database and adding said variable data to said fixed data so as to create a variable information print file.

12. The system according to claim 11, wherein said user input comprises an inquiry and said processor is further adapted to create said text string to include said inquiry.

13. The system according to claim 11, wherein said fixed data file comprises one of a portable document format (PDF) file and an open document format (ODF) file.

14. The system according to claim 11, wherein said text string comprise an extensible mark-up language (XML) file.

15. The system according to claim 11, wherein said node is exclusively dedicated to only performing variable information processing.

16. An apparatus comprising:
a graphic user interface adapted to receive user input;
a processor operatively connected to said graphic user interface, wherein said processor is adapted to create a fixed data file and a text string based on said user input;
a plurality of nodes operatively connected to said processor, wherein said processor is adapted to pass said fixed data file and said text string from said processor to at least one node; and
a database operatively connected to said node, wherein said node is adapted to execute said text string by retrieving variable data from said database and adding said variable data to said fixed data so as to create a variable information print file,
wherein said node is exclusively dedicated to only performing variable information processing.

17. The apparatus according to claim 16, wherein said user input comprises an inquiry and said processor is further adapted to create said text string to include said inquiry.

18. The apparatus according to claim 16, wherein said fixed data file comprises one of a portable document format (PDF) file and an open document format (ODF) file.

19. The apparatus according to claim 16, wherein said text string comprise an extensible mark-up language (XML) file.

20. A computer program product comprising:
a computer-usable data carrier storing instructions that, when executed by a computer, cause said computer to perform a method comprising:
receiving user input;
creating a fixed data file and a text string based on said user input;
supplying said fixed data file and said text string to at least one node within a system comprising a plurality of nodes; and
executing said text string at said node to add variable data to said fixed data and create a variable information print file,
wherein said executing of said text string comprises retrieving said variable data from a database within said system.
